(19) United States
(12) Patent Application Publication
(10) Pub. No.: US 2023/0206113 A1
(43) Pub. Date: Jun. 29, 2023

(54) FEATURE MANAGEMENT FOR MACHINE LEARNING SYSTEM

(71) Applicant: Advanced Micro Devices, Inc., Santa Clara, CA (US)

(72) Inventor: Sergey Blagodurov, Bellevue, WA (US)

(73) Assignee: Advanced Micro Devices, Inc., Santa Clara, CA (US)

(21) Appl. No.: 17/564,126

(22) Filed: Dec. 28, 2021

(51) Int. Cl. G06N 20/00

(52) U.S. Cl. CPC G06N 20/00

(57) ABSTRACT

A technique for processing images is disclosed. The technique includes tracking accesses, by a machine learning system, to individual features of a set of features, to generate an access count for each of the individual features; generating a rank for at least one of the individual features of the set of features based on the access count; and assigning the at least one of the individual features to a level of a memory hierarchy based on the rank.

### BACKGROUND

Machine learning techniques utilize a large amount of data for training purposes. Improvements to such techniques are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example computing device in which one or more features of the disclosure can be implemented;

FIG. 2 illustrates a feature analysis system for automatically evaluating and generating features for use in a machine learning system for placement into a memory hierarchy, according to an example;

FIGS. 3A-3C illustrate different example implementations of systems that include a feature analysis system; and

FIG. 4 is a flow diagram of a method for placing features within a memory hierarchy, according to an example.

### DETAILED DESCRIPTION

A technique for managing machine learning features is disclosed. The technique includes tracking accesses, by a machine learning system, to individual features of a set of features, to generate an access count for each of the individual features; generating a rank for at least one of the individual features of the set of features based on the access count; and assigning the at least one of the individual features to a level of a memory hierarchy based on the rank.

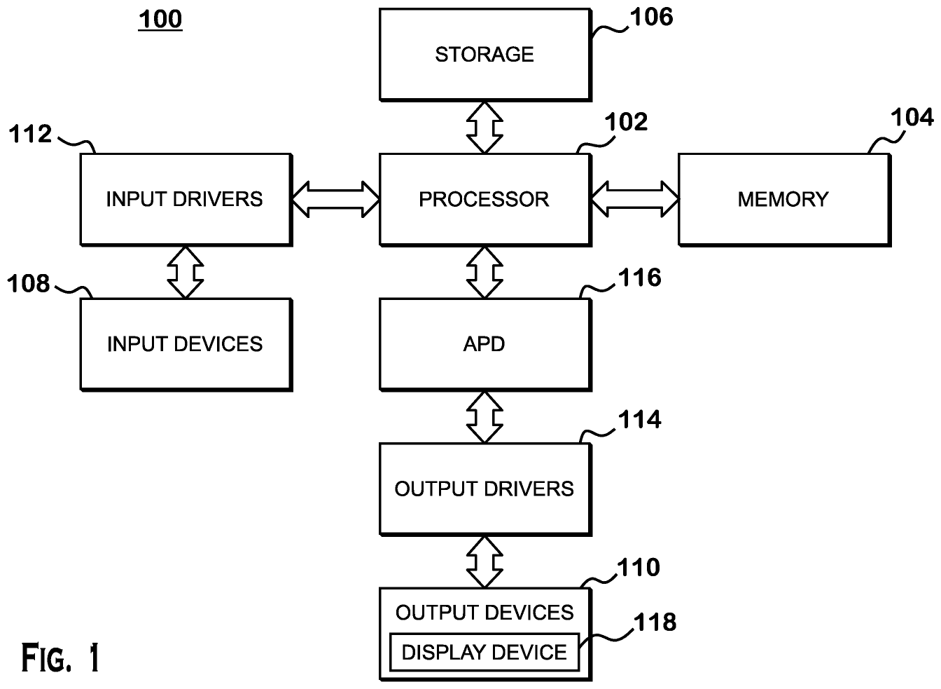

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes one or more processors 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, the memory 104 is located on the same die as one or more of the one or more processors 102, such as on the same chip or in an interposer arrangement, or is located separately from the one or more processors 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input drivers 112 and output drivers 114 include one or more hardware, software, and/or firmware components that interface with and drive input devices 108 and output devices 110, respectively. The input drivers 112 communicate with the one or more processors 102 and the input devices 108, and permit the one or more processors 102 to receive input from the input devices 108. The output drivers 114 communicate with the one or more processors 102 and the output devices 110, and permit the one or more processors 102 to send output to the output devices 110.

In some implementations, an accelerated processing device (“APD”) 116 is present. In some implementations, the APD 116 provides output to one or more output drivers 114. In some implementations, the APD 116 is used for general purpose computing and does not provide output to a display (such as display device 118). In other implementations, the APD 116 provides graphical output to a display 118 and, in some alternatives, also performs general purpose computing. In some examples, the display device 118 is a physical display device or a simulated device that uses a remote display protocol to display output. The APD 116 accepts compute commands and/or graphics rendering commands from the one or more processors 102, processes those compute and/or graphics rendering commands, and, in some examples, provides pixel output to display device 118 for display. The APD 116 includes one or more parallel processing units that perform computations in accordance with a single-instruction-multiple-data (“SIMD”) paradigm. In some implementations, the APD 116 includes dedicated graphics processing hardware (for example, implementing a graphics processing pipeline), and in other implementations, the APD 116 does not include dedicated graphics processing hardware. In some examples, the APD 116 includes or is a neural network accelerator.

Machine learning systems accept input data, process the input data, and produce output such as predictions, classifications, or other outputs. The input data is often not “raw data,” but is typically a feature vector. Raw data is data obtained from a system that is external to the machine learning system. Raw data is often not formatted in a way that is easily consumable by the machine learning system. In an example involving image classification, raw data is every pixel of an image, in a raw format. In another example involving processing data related to human beings, raw data is information about people, such as age, sex, health information, and the like. A feature vector includes one or more features derived from the raw data. Features are different from raw data in a variety of ways. For examples, features may include omissions, additions, or transformations of the raw data. A transformation is the processing and modification of the raw data to generate data not included in the raw data but that nevertheless characterizes the raw data. Features characterize the raw data in a way that is more amenable to usage in the machine learning system than the raw data itself.

Many machine learning systems are capable of accepting a very large number of possible types of features, but not requiring every possible type of feature to produce output. Thus it is possible to generate an output from the machine learning system by providing a subset of all possible features than the machine learning system can accept. In addition, it is possible that different types of features are used by the machine learning systems in ways that have different performance implications. For example, it is possible that some features are not very relevant to the outcome. Thus it is possible that for some such features, the machine learning system does not access such features very often. It is also possible that some features of a feature vector reflect information that is redundant with information reflected in other features of the feature vector. Thus it is possible for the machine learning system to access one feature fairly often and to access another, redundant, feature less often. In addition, it is possible that some feature types are simply accessed more often than other feature types due to the architecture of the machine learning system or for some other reason.

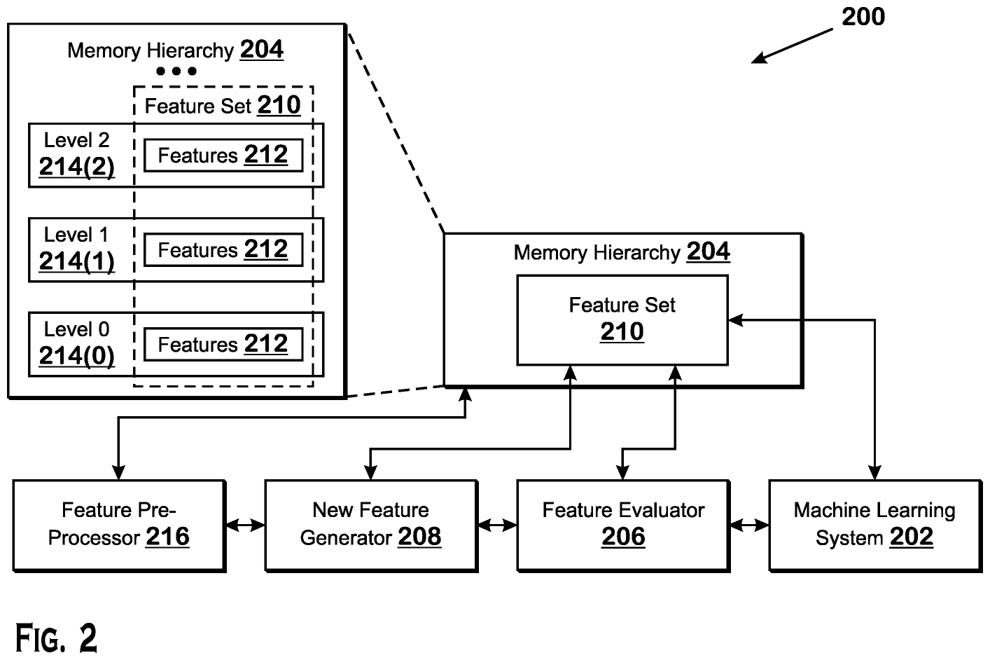

FIG. 2 illustrates a feature analysis system 200 for automatically evaluating and generating features for use in a machine learning system for placement into a memory hierarchy 204, according to an example. The system 200 includes a machine learning system 202, a feature evaluator 206, and a new feature generator 208. A memory hierarchy 204 stores a feature set 210. The feature set 210 includes features 212. The memory hierarchy 204 includes different levels 214. The levels 214 vary in terms of access latency and/or other characteristics such as bandwidth or energy consumption. More specifically, lower levels (e.g., level 0 214(0)) have better characteristics like lower access latency, higher bandwidth, or lower energy consumption than higher levels (e.g., level 1 214(1) or level 2 214(2)). Often, although not necessarily, lower levels have smaller capacity than higher levels. In an example, level 0 214(0) is volatile memory such as dynamic random access memory, level 1 214(1) is nonvolatile random access memory, and level 2 214(2) is a hard disk drive. Although a specific number of levels 214 is shown and described and a specific set of memory types is described for the levels 214, it should be understood that the memory hierarchy 204 may contain any number of levels 214 and those levels can be of different types, including those described or not described herein.

The memory hierarchy 204 stores a feature set 210, including features 212, for operation of the machine learning system 202. Due to the differing characteristics between the memory hierarchy levels 214, unused or rarely used features placed in a lower level 214 of the memory hierarchy 204 may crowd out space for more frequently used features that are placed in a higher level 214. In such situations, it could be advantageous for the frequently used features to be placed into a lower level 214 and for the more rarely used features to be placed into a higher level 214. In addition, it is possible that some feature types not included within the feature set 210, but that are nevertheless derivable from the feature types in the feature set 210 could be more useful than the features in the feature set 210.

The new feature generator 208, feature evaluator 206, and machine learning system 202 work together to profile the features 212 of the feature set 210 and to generate and profile new features from the features in the feature set 210. These elements perform several tasks to generate new features and classify features already in the feature set 210, and subsequently to store the features in a level 214 of the memory hierarchy 204.

The feature evaluator 206 generates feature vectors and provides those feature vectors to the machine learning system 202 for analysis. A feature vector is a set of features provided to the machine learning system 202 to obtain an output from the machine learning system 202. Each feature vector includes individual feature data items, where each such data item has a different feature type. A feature type is the type of information of the feature, and the feature data item is the actual value that the feature has. Different feature types are different ways of characterizing the raw data. Some different feature types are derived from different components of the raw data. Other different features types are derived at least in part from the same components of the raw data. The machine learning system 202 is capable of generating an output from a feature vector in which a subset (not all) of all possible feature types are provided. In addition, the machine learning system 202 is capable of generating an output from different feature vectors, having different sets of feature types.

The machine learning system 202 is a system that accepts feature vectors as input and provides an output. The output depends on the type of the machine learning system 202. A wide variety of types are contemplated. Some non-limiting examples include image classification, natural language processing, prediction networks that make predictions about subjects (e.g., people) based on data about the subjects (e.g., demographic data, personal history, etc.). Any type of machine learning system 202 is contemplated. Examples of contemplated machine learning systems 202 include systems based on convolutional neural networks, recurrent neural networks, artificial neural networks, deep neural networks, a combination thereof, and/or any other neural networking algorithm.

The new feature generator 208 generates new features from the features in the feature set 210. New features can be generated in any technically feasible manner. In one example, the new feature generator 208 generates new features by discretizing features that already exist in the feature set 210. Discretizing makes a range of values more coarse. In an example, if a feature is age of a person, and the feature can have a value of, for example, 0 to 120, a discretized version has a relatively smaller number of values, each of which represents a range of 0 to 120. In an example, one value represents 0-18, another value represents 18-35, another represents 35-65, and another represents 65-120. The new feature generator 208 is capable of discretizing any feature in the feature set 210 to generate a new feature. In another example, the new feature generator 208 generates new features by crossing already-existing features. Crossing two features means converting two distinct features into a single feature. Combinations of the values of the two combined features are made into individual values of the single, crossed feature. In an example, crossing gender (e.g., male and female) and education level (e.g., high school, undergrad, graduate) generates a gender-education level feature whose possible values are the combinations of the possible values of the gender and education level features. For example, the possible features of the gender-education level features are male-high school, male-undergrad, male-graduate, female-high school, female-undergrad, and female-graduate.

The new feature generator 208 generates these new features and places the new features into the memory hierarchy 204. The feature evaluator 206 evaluates these features and determines which level 214 to place the features into. Evaluating the features includes activating the machine learning system 202 and tracking accesses to the features of the feature set 210. In implementations, as the machine learning system 202 functions, the machine learning system 202 requests access to various features of the feature set 210. The machine learning system 202 accesses some features more than other features.

In some implementations, a feature pre-processor 216 is included with the system 200. The feature pre-processor processes features that are newly generated by the new feature generator 208 and/or processes features that already exist in the memory hierarchy 204. The feature pre-processor 216 discards features that meet a discard criteria. In some examples, the discard criteria is specified by user-specified code (such as a regular expression) that acts as filter to filter out features.

In some examples, the new feature generator 208 generates features from other features. In one example, the new feature generator 208 is programmed with user-supplied code that processes the features to generate a score, which is a feature. More specifically, it is possible for a user such as an operator of a neural network to provide executable code that analyzes one or more of the features to generate a score as a result of that feature. This generated score is, itself, a new feature. The new feature generator 208 includes that score feature in the memory hierarchy 204. In some examples, this score feature characterizes the underlying features (and thus raw data) in a more succinct format, and is thus consumable by the neural network utilizing fewer processing resources than more verbose data.

The feature evaluator 206 tracks the number of accesses to each feature type over a time period. The feature evaluator 206 ranks each feature type based on the number of accesses. A feature type for which more accesses have occurred is ranked higher than a feature type for which fewer accesses have occurred. In some examples, the feature evaluator 206 also applies a weight to one or more feature types to obtain a resulting weighted access score. In some such examples, the feature evaluator 206 ranks features having a higher score as higher than features having a lower score.

The feature evaluator 206 places features into the memory hierarchy 204 based on the rank described above. Higher ranked features are placed into lower levels 214 of the memory hierarchy, although features of different ranks can be placed in the same level 214. In an example, features are placed into the lowest level 214 up to the point where it is determined that there is insufficient space for features in the lowest level. Features of a lower rank are placed into a higher level up to the point where it is determined that there is insufficient space for features in that level, and so on.

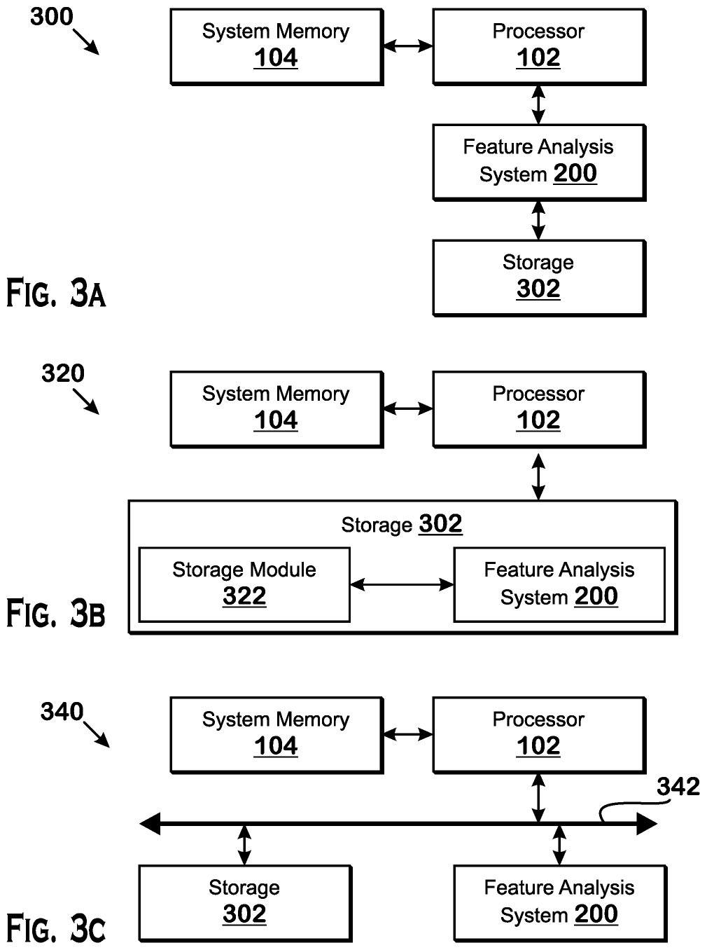

FIGS. 3A-3C illustrate different example implementations of systems that include a feature analysis system 200. In each of these figures, a feature analysis system 200 is shown. The feature analysis system 200 tracks accesses to features by the machine learning system 202. Any technically feasible means for tracking such accesses is possible. In some examples, the feature analysis system 200 requests that the processor 102 inform the feature analysis system 200 regarding which accesses have been made. In other examples, the feature analysis system 200 directly observes such accesses, for example, due to being interposed between the processor 102 and one or more elements of the memory hierarchy 204. FIG. 3A illustrates a system 300 in which the feature analysis system 200 exists between a storage 302 (which is a high level 214 of the memory hierarchy 204) and a processor 102 and system memory 104. In this example, the system 300 is a computation storage array. The feature analysis system 200 acts as an interface between the processor 102 and system memory 104, and the storage 302, as can be seen. In this system 300, the memory hierarchy 204 includes the system memory 104 (a lower level 214) and the storage 302 (a higher level 214). The feature analysis system 200 is thus capable of analyzing the features stored in the system memory 104 and the storage 302 according to the techniques described herein, to generate new features, and to move features between the levels 214 based on ranking as described.

FIG. 3B illustrates a system 320 including a storage 302 interfaced with the processor 102 and the system memory 104. The storage 302 includes the feature analysis system 200 and one or more storage modules 322. A storage module 322 includes storage elements such as non-volatile flash memory or another type of storage. In this example, the feature analysis system 200 is embodied with a computational storage device 302. As described elsewhere herein, the feature analysis system 200 is able to analyze features stored within the memory hierarchy, which includes the system memory 104 and the storage module 322, and moves the features between these items according to the ranks.

FIG. 3C illustrates a system 340 including a storage 302 as a peer to the feature analysis system 200. The processor 102 is coupled to a bus 342, which is coupled to the storage 302 and the feature analysis system 200. In some examples, the system 340 is a computational storage processor in which the feature analysis system 200 is a peer with the storage system 302. In an example, the bus 342 is a peripheral bus such as a peripheral component interconnect express (PCIe) bus. As with the systems of FIGS. 3A and 3B, the feature analysis system 200 generates features and places the features into the memory hierarchy, including the storage 302 and the system memory 104.

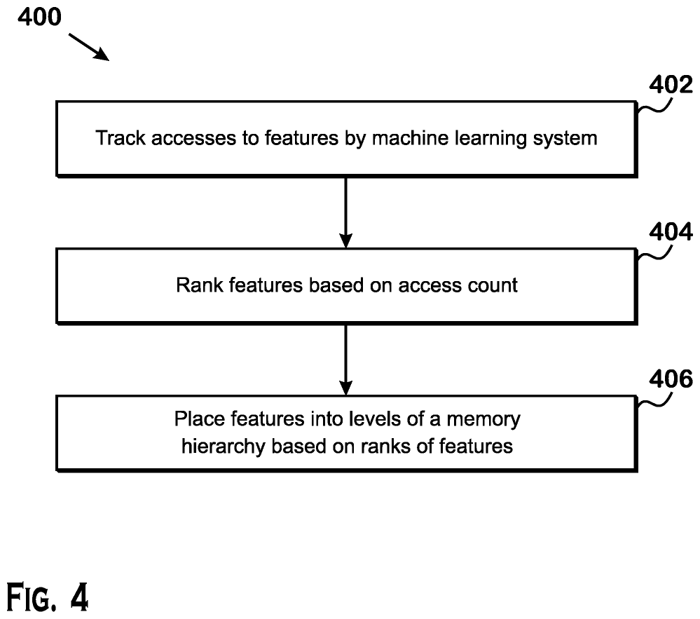

FIG. 4 is a flow diagram of a method 400 for placing features within a memory hierarchy, according to an example. Although described with respect to the system of FIGS. 1-3C, those of skill in the art will understand that any system, configured to perform the steps of the method 400 in any technically feasible order, falls within the scope of the present disclosure.

At step 402, a feature evaluator 206 tracks accesses to features by a machine learning system 202. As described elsewhere herein, the machine learning system 202 is capable of accessing features of different types at different points in processing. It is possible that the machine learning system 202 access different feature types with different frequency. The feature evaluator 206 tracks the number of accesses to different feature types and stores values indicating those numbers. It should be understood that the number of accesses represents a number of accesses to a type of feature, not to individual feature values.

At step 404, the feature evaluator 206 ranks the features based on the tracked access count. In some examples, the feature evaluator 206 applies weights to one or more of the access counts. In some examples, the weights are specified for one or more feature types. In some examples, the weights are provided by a human operator of the machine learning system 202 or are provided from some other source.

Ranking the features includes assigning a rank based on the tracked number, possibly modified by the count. In some examples, the feature evaluator 206 assigns a lower rank to a feature type having a higher count. In other examples, the feature evaluator 206 assigns a lower rank to a feature type having a higher weighted count.

At step 406, the feature evaluator 206 places the features into levels 214 of a memory hierarchy 204 based on the ranks. Lower ranked features are placed into lower levels 214 of the memory hierarchy 204. In some examples, the feature evaluator 206 designates feature ranks to levels 214 based on the number of features compared with the capacity of the levels 214. In an example, features are placed into a lower level 214 until that level is deemed to have no additional space for features. At that point, features having a higher rank are placed into a higher level 214, and so on.

In some examples, a new feature generator 208 generates new features for placement into the memory hierarchy 204. Example techniques for generating new features includes crossing already existing features, discretizing already existing features, or generating scores from features. It is possible for the new feature generator to discard generated features based on a filter function such as a regular expression or in some other manner.

The elements in the figures are embodied as, where appropriate, software executing on a processor, a fixed-function processor, a programmable processor, or a combination thereof. For example, the feature pre-processor 216, the new feature generator 208, the feature evaluator 206, and the machine learning system 202 are all implemented as one or more of software executing on a processor, a fixed-function processor, a programmable processor, or some combination thereof. In addition is it possible for any of the feature pre-processor 216, the new feature generator 208, the feature evaluator 206, and the machine learning system 202 to be integrated within and/or to be a single component. The storage 302 and storage module 322 of FIGS. 3A-3C include elements for storing data in a non-volatile manner, such as magnetic storage or flash storage.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for managing machine learning features, the method comprising:
tracking accesses, by a machine learning system, to individual features of a set of features, to generate an access count for each of the individual features;
generating a rank for at least one of the individual features of the set of features based on the access count; and
assigning the at least one of the individual features to a level of a memory hierarchy based on the rank.

2. The method of claim 1, further comprising:
applying a weight to the access count to generate a weighted access count.

3. The method of claim 2, wherein generating the rank occurs based on the weighted access count.

4. The method of claim 1, further comprising generating ranks for a plurality of individual features of the set of features, the ranks including the rank for the at least one of the individual features, wherein generating the ranks includes assigning lower ranks to individual features having higher access counts and assigning higher ranks to individual features having lower access counts.

5. The method of claim 4, further comprising assigning the plurality of individual features of the set of features to levels of the memory hierarchy based on the ranks, wherein assigning the plurality of individual features to the levels of the memory hierarchy comprises assigning individual features having lower ranks to lower levels of the memory hierarchy and assigning individual features having higher ranks to higher levels of the memory hierarchy.

6. The method of claim 1, further comprising generating new features based on the set of features.

7. The method of claim 6, further comprising filtering the new features.

8. The method of claim 1, further comprising generating a score from the set of features.

9. The method of claim 6, wherein generating the new features comprises performing one or both of crossing and discretization on the set of features.

10. A system comprising:
a memory hierarchy; and
a feature analysis system
wherein the feature analysis system is configured to:
track accesses, by a machine learning system, to individual features of a set of features, to generate an access count for each of the individual features;
generate a rank for at least one of the individual features of the set of features based on the access count; and
assign the at least one of the individual features to a level of the memory hierarchy based on the rank.

11. The system of claim 10, wherein the memory hierarchy is further configured to:
apply a weight to the access count to generate a weighted access count.

12. The system of claim 11, wherein generating the rank occurs based on the weighted access count.

13. The system of claim 10, wherein the feature analysis system is further configured to generate ranks for a plurality of individual features of the set of features, the ranks including the rank for the at least one of the individual features, wherein generating the ranks includes assigning lower ranks to individual features having higher access counts and assigning higher ranks to individual features having lower access counts.

14. The system of claim 13, wherein the feature analysis system is further configured to assign the plurality of individual features of the set of features to levels of the memory hierarchy based on the ranks, wherein assigning the plurality of individual features to the levels of the memory hierarchy comprises assigning individual features having lower ranks to lower levels of the memory hierarchy and assigning individual features having higher ranks to higher levels of the memory hierarchy.

15. The system of claim 10, wherein the feature analysis system is further configured to generate new features based on the set of features.

16. The system of claim 10, wherein the feature analysis system is further configured to filter the generated new features.

17. The system of claim 10, wherein the feature analysis system is further configured to generate a score from the set of features.

18. The system of claim 17, wherein generating the new features comprises performing one or both of crossing and discretization on the set of features.

19. A non-transitory computer-readable medium storing instructions that, when executed by a processor, cause the processor to perform operations including:
tracking accesses, by a machine learning system, to individual features of a set of features, to generate an access counts for each of the individual features;
generating a rank for at least one of the individual features of the set of features based on the access count; and
assigning the at least one of the individual features to a level of a memory hierarchy based on the rank.

20. The non-transitory computer-readable medium of claim 19, wherein the memory hierarchy is further configured to:
apply a weight to the access count to generate a weighted access count.
